(19) United States
(12) Patent Application Publication
(10) Pub. No.: US 2013/0133002 A1
(43) Pub. Date: May 23, 2013

(54) METHOD FOR PERFORMING INTELLIGENT RECOMMENDATION/SELECTION OF MULTICHANNEL BROADCASTING PROGRAMS, AND ASSOCIATED APPARATUS

(71) Applicant: Jinlong Li, Anhui Province (CN)

(72) Inventor: Jinlong Li, Anhui Province (CN)

(21) Appl. No.: 13/382,290

(22) PCT Filed: Nov. 18, 2011
(86) PCT No.: PCT/CN11/82441

§ 371 Date: Jan. 5, 2012

(51) Int. Cl. H04N 21/40

(52) U.S. Cl. 725/38

(57) ABSTRACT

A method for performing intelligent recommendation/selection of multichannel broadcasting programs includes: calculating a difference between a start time of each of at least one portion of the multichannel broadcasting programs and a specific time; and setting priority of each of the at least one portion of the multichannel broadcasting programs according to the difference, for use of performing intelligent recommendation/selection. An associated apparatus for performing intelligent recommendation/selection of multichannel broadcasting programs is also provided. For example, the apparatus is utilized for viewing one or more of the multichannel broadcasting programs. The apparatus includes a processing circuit arranged to perform intelligent recommendation/selection, where the processing circuit includes a calculation module and a priority control module, for performing operations of the method. In particular, various modes such as a normal recommending (NR) mode, an automatic recommending (AR) mode, and an intelligent program-viewing plan (IPP) mode may be involved with the method.

### FIELD OF INVENTION

The present invention relates to audio/video systems for viewing multichannel broadcasting programs, and more particularly, to a method for performing intelligent recommendation/selection of multichannel broadcasting programs, and to an associated apparatus.

### BACKGROUND OF THE INVENTION

Typically, a television (TV) or a TV receiver can receive broadcasting signals carrying multichannel broadcasting programs for a user. For example, the TV can receive the broadcasting signal carrying a multichannel broadcasting program and display images of the multichannel broadcasting program. In another example, the TV receiver can receive the broadcasting signal carrying a multichannel broadcasting program and output audio/video signals of the multichannel broadcasting program. In a situation where the broadcasting signal carrying the multichannel broadcasting programs are received without being cached, the missing multichannel broadcasting programs or the missing part of any multichannel broadcasting program cannot be viewed again.

As the channels are many, the user cannot spend his/her time on each of the channels at the same time. When the user picks up a remote controller of the TV or the TV receiver and presses a button thereon to jump to a new channel, the user typically encounters the problem that the multichannel broadcasting program of the new channel has been broadcasted for a while, where the user cannot control the missing part of the multichannel broadcasting program to be replayed. As long as the user switches from one channel to another channel all the way, the same problem may occur. It is a pity that the user can merely view the remaining part of the multichannel broadcasting program. Thus, a novel method is required in order to provide the user with better viewing experience of multichannel broadcasting programs.

### SUMMARY OF THE INVENTION

It is therefore an objective of the claimed invention to provide a method for performing intelligent recommendation/selection of multichannel broadcasting programs, and to provide an associated apparatus, in order to solve the above-mentioned problem.

An exemplary embodiment of a method for performing intelligent recommendation/selection of multichannel broadcasting programs comprises: calculating a difference between a start time of each of at least one portion of the multichannel broadcasting programs and a specific time; and setting priority of each of the at least one portion of the multichannel broadcasting programs according to the difference, for use of performing intelligent recommendation/selection.

An exemplary embodiment of an associated apparatus for performing intelligent recommendation/selection of multichannel broadcasting programs is provided. The apparatus comprises a processing circuit arranged to perform intelligent recommendation/selection, wherein the processing circuit comprises a calculation module and a priority control module. The calculation module is arranged to calculate a difference between a start time of each of at least one portion of the multichannel broadcasting programs and a specific time. In addition, the priority control module is arranged to set priority of each of the at least one portion of the multichannel broadcasting programs according to the difference, for use of performing intelligent recommendation/selection.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a diagram of an apparatus for performing intelligent recommendation/selection of multichannel broadcasting programs according to a first embodiment of the present invention.

FIGS. 1B-1C respectively illustrate some implementation details involved with the apparatus shown in FIG. 1A according to different embodiments of the present invention.

FIG. 2 is a flowchart of a method for performing intelligent recommendation/selection of multichannel broadcasting programs according to an embodiment of the present invention.

FIGS. 3A-3D illustrate some implementation details of the method shown in FIG. 2 according to an embodiment of the present invention.

FIGS. 4A-4E illustrate some implementation details of the method shown in FIG. 2 according to another embodiment of the present invention.

FIGS. 5A-5D illustrate some implementation details of the method shown in FIG. 2 according to another embodiment of the present invention.

FIG. 6 is a diagram of an apparatus for performing intelligent recommendation/selection of multichannel broadcasting programs according to a second embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

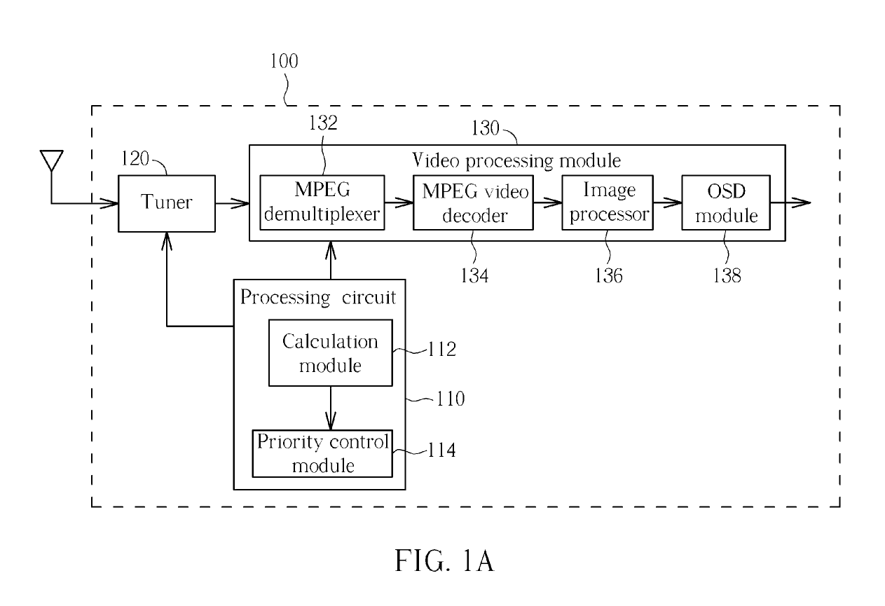

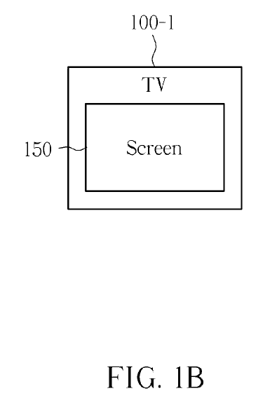

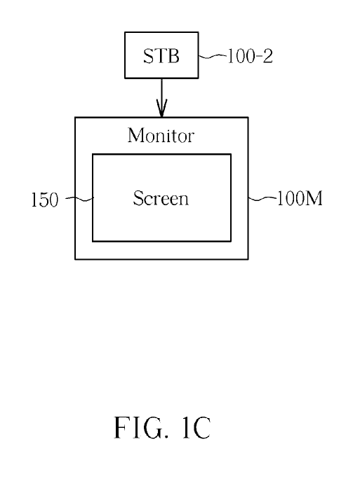

Please refer to FIG. 1A, which illustrates a diagram of an apparatus 100 for performing intelligent recommendation/selection of multichannel broadcasting programs (e.g. intelligent recommendation and/or intelligent selection regarding the multichannel broadcasting programs) according to a first embodiment of the present invention. For example, the apparatus 100 can be utilized for viewing one or more of the multichannel broadcasting programs. The apparatus 100 comprises a processing circuit 110 arranged to control operations of a multimedia player, where the processing circuit 110 comprises a calculation module 112 and a priority control module 114. In particular, the apparatus 100 of this embodiment may further comprise a tuner 120, and a video processing module 130. The tuner 120 is arranged to select one of a plurality of channels, and the video processing module 130 is arranged to perform video processing. For example, the tuner 120 can be a digital tuner and the video processing module 130 can be a digital processing module implemented with digital signal processing (DSP) technology. In another example, the tuner 120 can be an analog tuner and the video processing module 130 can be a signal processing module.

According to a special case of this embodiment, in a situation where the tuner 120 is a digital tuner, the video processing module 130 can be a video processing circuit comprising a Moving Picture Experts Group (MPEG) demultiplexer 132, an MPEG video decoder 134, and an image processor 136 (which are illustrated as an example of the architecture of the video processing module 130 shown in FIG. 1A, for better comprehension). The MPEG demultiplexer 132 is arranged to demultiplex video content and audio content of a program on the channel selected by the tuner 120 such as the digital tuner. In addition, the MPEG video decoder 134 is arranged to decode the video content demultiplexed by the MPEG demultiplexer 132, and more particularly, to perform MPEG-decoding on the video content. Additionally, the image processor 136 may further perform image processing on the decoded video content to be displayed. This is for illustrative purposes only, and is not meant to be a limitation of the present invention. In a situation where the tuner 120 is an analog tuner, the video processing module 130 may comprise some components arranged to perform signal processing, where implementing the MPEG demultiplexer 132, the MPEG video decoder 134, and the image processor 136 mentioned above within the video processing module 130 is not required. Please note that, no matter whether the tuner 120 is a digital tuner or an analog tuner, the video processing module 130 may further comprise an on screen display (OSD) module 138 arranged to perform OSD operations under control of the processing circuit 110, in order to mix OSD information into the video content to be displayed. In addition, according to different variations of this embodiment, a display module can be integrated into the apparatus 100.

According to the embodiment shown in FIG. 1A, the processing circuit 110 is arranged to perform intelligent recommendation/selection. More particularly, the calculation module 112 is arranged to calculate a difference between a start time of each of at least one portion of the multichannel broadcasting programs and a specific time. In addition, the priority control module 114 is arranged to set priority of each of the at least one portion of the multichannel broadcasting programs according to the difference, for use of performing intelligent recommendation/selection. In practice, the apparatus 100 (and more particularly, the processing circuit 110) may comprise at least one storage unit (not shown in FIG. 1A, for brevity) for storing intelligent recommendation/selection information which can be utilized for intelligent recommendation/selection control, where the intelligent recommendation/selection information may be implemented with at least one table (e.g. one or more tables) and/or at least one list (e.g. one or more lists). For example, the aforementioned at least one storage unit can be arranged to temporarily store at least one table/list for intelligent recommendation control. In another example, the aforementioned at least one storage unit can be arranged to temporarily store at least one table/list for intelligent selection control. In another example, the aforementioned at least one storage unit can be arranged to temporarily store at least one table/list for intelligent recommendation and intelligent selection control.

Please note that the implementation of the apparatus 100 may vary according to different embodiments, such as the embodiment shown in FIG. 1A or some variations thereof. For example, the apparatus 100 may comprise at least one portion (e.g. a portion or all) of the multimedia player. In a situation where the apparatus 100 comprises a portion of the multimedia player, the processing circuit 110 can be the control circuit of the multimedia player, such as an integrated circuit (IC). In a situation where the apparatus 100 comprises the whole of the multimedia player, the apparatus 100 can be the multimedia player, or can be an audio/video reproducing system comprising the multimedia player.

In some embodiments, such as the embodiment shown in FIG. 1A or some variations thereof, the multimedia player mentioned above can be one of a digital video recorder (DVR) (which can be equipped with program receiving functionality, for example), an optical disc player, a set top box (STB), a television (TV), and a TV receiver, or can be a combination of a DVR, an optical disc player, an STB, a TV, and/or a TV receiver. According to one of these embodiments, such as that shown in FIG. 1B, the multimedia player can be a TV 100-1 comprising a screen 150 (e.g. a liquid crystal display (LCD) panel) for displaying images of a program, where the apparatus 100 may comprise at least one portion (e.g. a portion or all) of the TV 100-1. According to another of these embodiments, such as that shown in FIG. 1C, the multimedia player can be an STB 100-2, which is typically electronically connected to a monitor 100M, where the apparatus 100 may comprise at least one portion (e.g. a portion or all) of the STB 100-2. For example, the monitor 100M comprises the screen 150 (e.g. an LCD panel) arranged to display images of a program, and more particularly, the images carried by at least one signal sent from the STB 100-2.

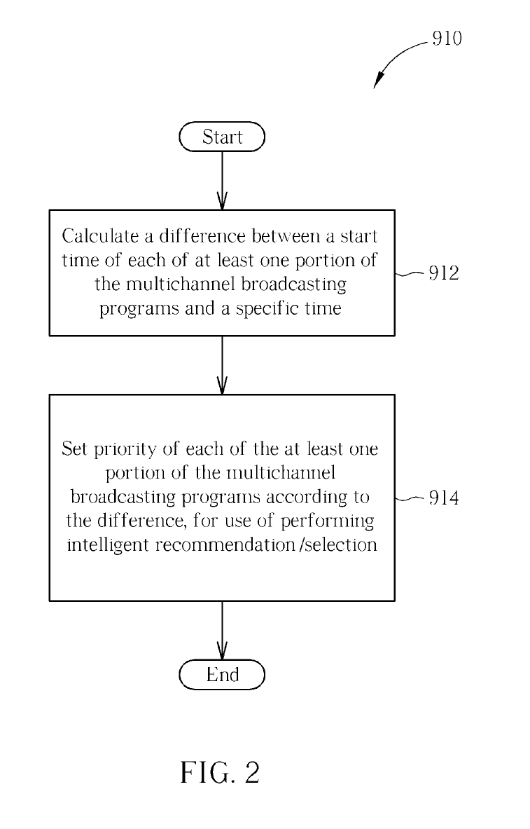

FIG. 2 is a flowchart of a method 910 for performing intelligent recommendation/selection of multichannel broadcasting programs according to an embodiment of the present invention. The method 910 shown in FIG. 2 can be applied to the apparatus 100 shown in FIG. 1A. The method is described as follows.

In Step 912, the calculation module 112 calculates a difference Dₚ between a start time Sₚ of each of at least one portion of the multichannel broadcasting programs (e.g. the program set {p}, which may comprise one or more of the multichannel broadcasting programs) and a specific time T₀. For example, the aforementioned at least one portion of the multichannel broadcasting programs (e.g. the program set {p}) may comprise a first multichannel broadcasting program p1 and a second multichannel broadcasting program p2, where the calculation module 112 calculates a first difference Dₚ₁ between a first start time Sₚ₁ of the first multichannel broadcasting program p1 and the specific time T₀, and further calculates a second difference Dₚ₂ between a second start time Sₚ₂ of the second multichannel broadcasting program p2 and the specific time T₀. More particularly, the first difference Dₚ₁ can be an absolute value |Sₚ₁−T₀| of a difference (Sₚ₁−T₀) between the first start time Sₚ₁ and the specific time T₀, and the second difference Dₚ₂ can be an absolute value |Sₚ₂−T₀| of a difference (Sₚ₂−T₀) between the second start time Sₚ₂ and the specific time T₀. For example, each difference Dₚ of the difference set {Dₚ} corresponding to the program set {p} can be calculated in the same manner. In this situation, the difference Dₚ mentioned above can be written as follows:

Dₚ=|Sₚ−T₀|.

According to some aspects of this embodiment, the specific time T₀ can be a time point under consideration. For example, the specific time T₀ can be the current time.

In Step 914, the priority control module 114 sets priority of each of the aforementioned at least one portion of the multichannel broadcasting programs (e.g. the program set {p}) according to the difference Dₚ, for use of performing intelligent recommendation/selection. For example, in a situation where the aforementioned at least one portion of the multichannel broadcasting programs (e.g. the program set {p}) comprises the first multichannel broadcasting program p1 and the second multichannel broadcasting program p2 mentioned above, when the first difference Dₚ₁ is less than the second difference Dₚ₂ (i.e. Dₚ₁<Dₚ₂), the priority control module 114 sets priority of the first multichannel broadcasting program p1 to be higher than that of the second multichannel broadcasting program p2, for use of performing intelligent recommendation/selection. That is, in this situation, the first multichannel broadcasting program p1 is more recommended than the second multichannel broadcasting program P2 at the specific time T₀ such as the time point under consideration.

In practice, each start time Sₚ of the start time set {Sₚ} corresponding to the program set {p} can be obtained from reference information regarding the program set {p}. For example, the reference information can be obtained by detecting the appearance of each multichannel broadcasting program p of the program set {p}. In another example, the reference information can be obtained from an electronic program guide (EPG). In addition, each ending time Eₚ of the ending time set {Eₚ} corresponding to the program set {p} can be determined to be the start time of the multichannel broadcasting program next to the multichannel broadcasting program p under consideration on the same channel.

Please note that, according to some variations of this embodiment, operations of Step 912 and Step 914 can be performed repeatedly. In addition, according to some variations of this embodiment, at least one portion (e.g. a portion or all) of the operations of Step 912 and at least one portion (e.g. a portion or all) of the operations of Step 914 can be performed at the same time. Additionally, according to some variations of this embodiment, operations of Step 912 and Step 914 can be performed repeatedly, and at least one portion (e.g. a portion or all) of the operations of Step 912 and at least one portion (e.g. a portion or all) of the operations of Step 914 can be performed at the same time.

In some embodiments, such as the embodiment shown in FIG. 2 or some variations thereof, in a normal recommending (NR) mode, in response to trigger from a user, the processing circuit 110 provides the user with a recommending list through a user interface module (e.g. a display module such as that mentioned above), where the recommending list comprises at least one recommended channel (e.g. one or more recommended channels) corresponding to at least one multichannel broadcasting program of the multichannel broadcasting programs mentioned above, and more particularly, a set of recommended channels corresponding to two or more of the multichannel broadcasting programs mentioned above. Thus, the user may select a channel according to the recommending list. This is for illustrative purposes only, and is not meant to be a limitation of the present invention. According to some embodiments, such as the embodiment shown in FIG. 2 or some variations thereof, in an automatic recommending (AR) mode, when the current multichannel broadcasting program comes to an end, the processing circuit 110 controls the tuner 120 to automatically switch/tune to a channel corresponding to a multichannel broadcasting program to be viewed, where the multichannel broadcasting program to be viewed can be automatically selected from the aforementioned at least one portion of the multichannel broadcasting programs. More particularly, the specific time T₀ can be the current time. In the AR mode, when an ending time of the current multichannel broadcasting program falls within a predetermined period since the current time, the processing circuit 110 prompts the user with a message indicating the multichannel broadcasting program to be viewed. For example, the predetermined period can be equal to three minutes. In a situation where the current multichannel broadcasting program will come to the end within three minutes, the processing circuit 110 prompts the user with the message indicating the multichannel broadcasting program to be viewed next.

Please note that, in some embodiments, the processing circuit 110 may control the apparatus 100 to exit the AR mode automatically when it is detected that there is no user interaction for a while. For example, when it is detected that there is no user activity (such as pressing a button on a remote controller of the apparatus 100) for a predetermined time period (e.g. several hours), the processing circuit 110 controls the apparatus 100 to exit the AR mode automatically.

According to some embodiments, such as the embodiment shown in FIG. 2 or some variations thereof, in an intelligent program-viewing plan (IPP) mode, the processing circuit 110 provides the user with at least one hint through a user interface module such as that mentioned above, allowing the user to designate a preferred program-viewing plan within a plurality of program-viewing plans, where the preferred program-viewing plan is associated to a recommending list comprising at least one recommended channel (e.g. one or more recommended channels) corresponding to at least one multichannel broadcasting program of the multichannel broadcasting programs mentioned above, such as a recommending list comprising a set of recommended channels corresponding to two or more of the multichannel broadcasting programs.

In practice, the aforementioned at least one hint may represent a program-viewing plan list displayed on the screen 150, where the program-viewing plan list comprises items that represent the plurality of program-viewing plans, respectively. For example, the most recommend program-viewing plan(s) within the plurality of program-viewing plans can be positioned on the topmost of the program-viewing plan list mentioned above. Based upon the program-viewing plans, the user can view his/her preferred multichannel broadcasting programs one by one in excellent order easily.

According to some embodiments, such as the embodiment shown in FIG. 2 or some variations thereof, the processing circuit 110 provides the user with at least one hint through a user interface module such as that mentioned above, allowing the user to login for recording user preference statistics data corresponding to the user, for use of user preference control (UPC). More particularly, the user preference statistics data may comprise data regarding multichannel broadcasting program(s) that are most viewed by the user. For example, multiple modes such as those mentioned above (e.g. the NR mode, the AR mode, and the IPP mode) may be involved. In one of the NR mode, the AR mode, and the IPP mode, the processing circuit 110 can set the priority of each of the aforementioned at least one portion of the multichannel broadcasting programs (e.g. each multichannel broadcasting program p of the program set {p}) according to the user preference statistics data.

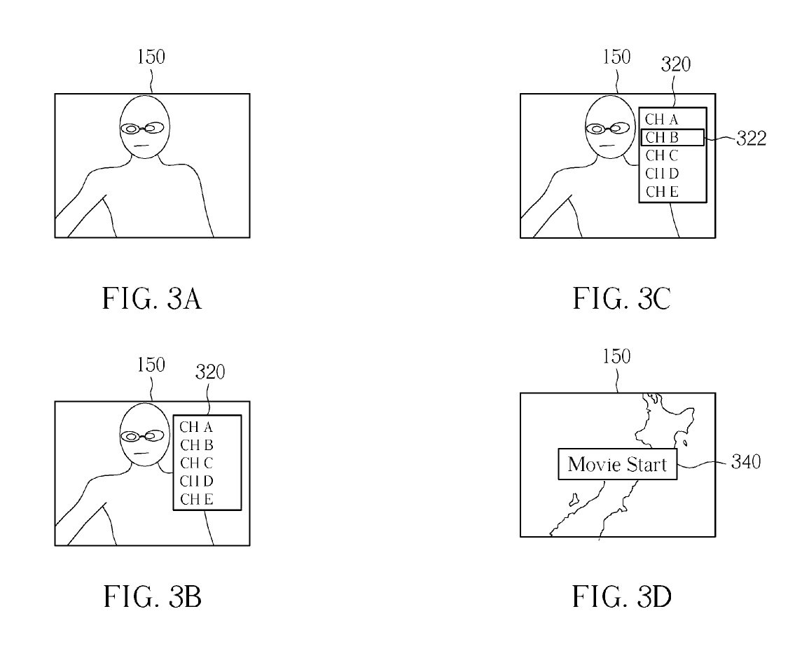

FIGS. 3A-3D illustrate some implementation details of the method 910 shown in FIG. 2 according to an embodiment of the present invention. The aforementioned NR mode is involved in this embodiment. As shown in FIG. 3A, the apparatus 100 is playing the current multichannel broadcasting program, and some video contents of the current multichannel broadcasting program is displayed on the screen 150. Referring to FIG. 3B, in the NR mode, in response to trigger from the user (e.g. the user calls the NR function through a button on the remote controller of the apparatus 100), the processing circuit 110 provides the user with a recommending list 320 that is displayed on the screen 150, where the recommending list 320 comprises a set of recommended channels (respectively labeled “CH A”, “CH B”, “CH C”, “CH D”, and “CH E” in FIG. 3B, for example) corresponding to some of the multichannel broadcasting programs mentioned above. Referring to FIG. 3C, the user may select an item 322 representing a recommended channel (labeled “CH B”, for example) corresponding to a new multichannel broadcasting program to be viewed. As a result, referring to FIG. 3D, the processing circuit 110 controls the tuner 120 to switch/tune to the recommended channel corresponding to the new multichannel broadcasting program, and provides the user with a message 340 (labeled “Movie Start” in FIG. 3D, for example) for indicating this operation.

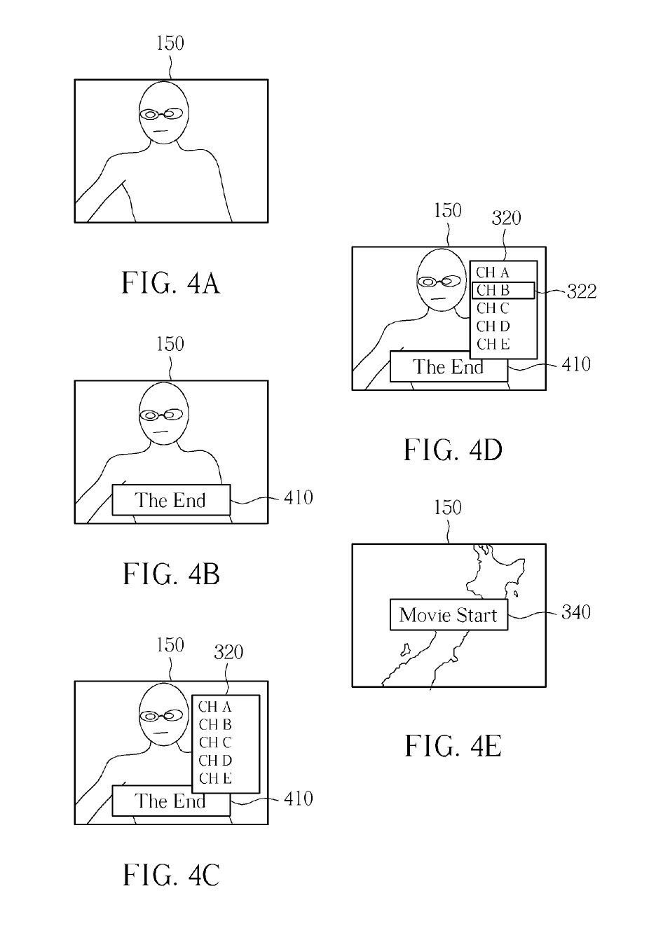

FIGS. 4A-4E illustrate some implementation details of the method 910 shown in FIG. 2 according to another embodiment of the present invention. The aforementioned AR mode is involved in this embodiment. As shown in FIG. 4A, the apparatus 100 is playing the current multichannel broadcasting program, and some video contents of the current multichannel broadcasting program is displayed on the screen 150. Referring to FIG. 4B, in the AR mode, when the current multichannel broadcasting program comes to an end (or is going to come to the end), the processing circuit 110 provides the user with a message 410 (labeled “The end” in FIG. 4B) for indicating this situation. In addition, referring to FIG. 4C, the processing circuit 110 provides the user with the recommending list 320 that is displayed on the screen 150, where the recommending list 320 comprises a set of recommended channels (respectively labeled “CH A”, “CH B”, “CH C”, “CH D”, and “CH E” in FIG. 4C, for example) corresponding to some of the multichannel broadcasting programs mentioned above. Next, referring to FIG. 4D, the processing circuit 110 highlights the item 322 representing the recommended channel (labeled “CH B”, for example) corresponding to the new multichannel broadcasting program to be viewed, where the new multichannel broadcasting program can be automatically selected from the aforementioned at least one portion of the multichannel broadcasting programs. For example, the processing circuit 110 can perform UPC operations to select the new multichannel broadcasting program from the program set {p}. As a result, referring to FIG. 4E, the processing circuit 110 controls the tuner 120 to automatically switch/tune to the recommended channel corresponding to the new multichannel broadcasting program to be viewed, and provides the user with the message 340 (labeled “Movie Start” in FIG. 4E, for example) for indicating this operation.

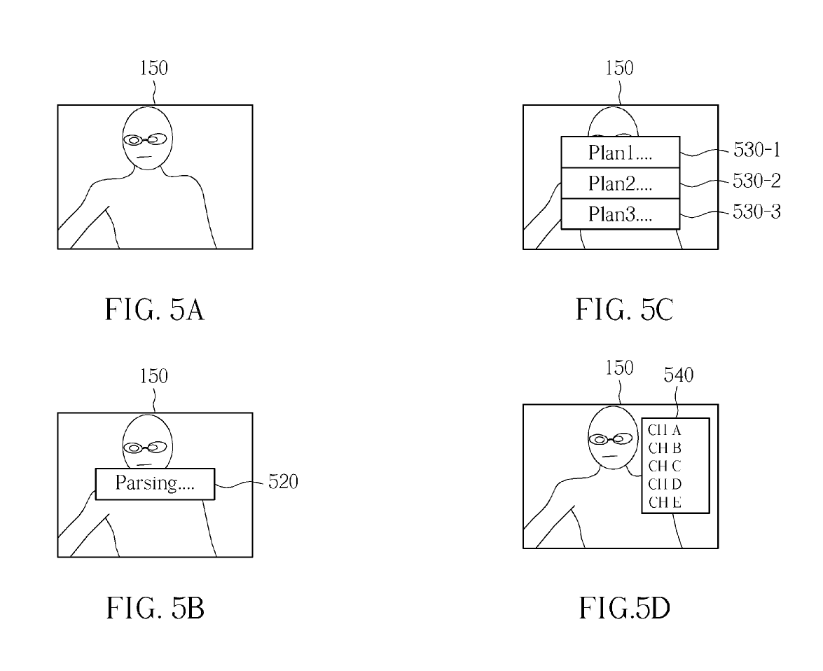

FIGS. 5A-5D illustrate some implementation details of the method 910 shown in FIG. 2 according to another embodiment of the present invention. The aforementioned IPP mode is involved in this embodiment. As shown in FIG. 5A, the apparatus 100 is playing the current multichannel broadcasting program, and some video contents of the current multichannel broadcasting program is displayed on the screen 150. Referring to FIG. 5B, in the IPP mode, the processing circuit 110 parses the latest version of the user preference statistics data mentioned above according to the difference Dₚ (more particularly, each difference Dₚ of the difference set {Dₚ}) in order to generate a plurality of program-viewing plans, and provides the user with the message 520 (labeled “Parsing . . . ” in FIG. 5B) for indicating this operation. Referring to FIG. 5C, the processing circuit 110 provides the user with at least one hint displayed on the screen 150, and more particularly, provides the user with a plurality of hints 530-1, 530-2, and 530-3 (respectively labeled “Plan 1 . . . ”, “Plan 2 . . . ”, and “Plan 3 . . . ” in FIG. 5C, for example), where the hints 530-1, 530-2, and 530-3 represent the plurality of program-viewing plans mentioned above, respectively. According to this embodiment, each of the program-viewing plans is associated to a recommending list comprising at least one recommended channel (e.g. one or more recommended channels) corresponding to at least one multichannel broadcasting program of the multichannel broadcasting programs mentioned above, such as a recommending list comprising a set of recommended channels corresponding to two or more of the multichannel broadcasting programs. In a situation where the user designates a preferred program-viewing plan within the plurality of program-viewing plans, such as that represented by the hint 530-1 (labeled “Plan 1 . . . ” in FIG. 5C, for example), the processing circuit 110 provides the user with a recommending list 540 displayed on the screen 150 shown in FIG. 5D, where the preferred program-viewing plan is associated to the recommending list 540. In this embodiment, the recommending list 540 may comprise a set of recommended channels (respectively labeled “CH A”, “CH B”, “CH C”, “CH D”, and “CH E” in FIG. 5D, for example) corresponding to some of the multichannel broadcasting programs mentioned above.

In addition, according to the recommending list 540, the user may select an item representing a recommended channel corresponding to a new multichannel broadcasting program to be viewed, such as that labeled “CH B” in FIG. 5D, for example. As a result, the processing circuit 110 controls the tuner 120 to switch/tune to the recommended channel corresponding to the new multichannel broadcasting program, and provides the user with a message for indicating this operation. This is for illustrative purposes only, and is not meant to be a limitation of the present invention. According to a variation of this embodiment, the item representing the recommended channel corresponding to the new multichannel broadcasting program to be viewed is not selected by the user. More particularly, the processing circuit 110 of this variation highlights the item representing the recommended channel corresponding to the new multichannel broadcasting program to be viewed, such as that labeled “CH B” in FIG. 5D, for example, where the new multichannel broadcasting program can be automatically selected from the aforementioned at least one portion of the multichannel broadcasting programs. For example, the processing circuit 110 can perform UPC operations to select the new multichannel broadcasting program from the program set {p}. As a result, the processing circuit 110 controls the tuner 120 to automatically switch/tune to the recommended channel corresponding to the new multichannel broadcasting program to be viewed, and provides the user with a message for indicating this operation.

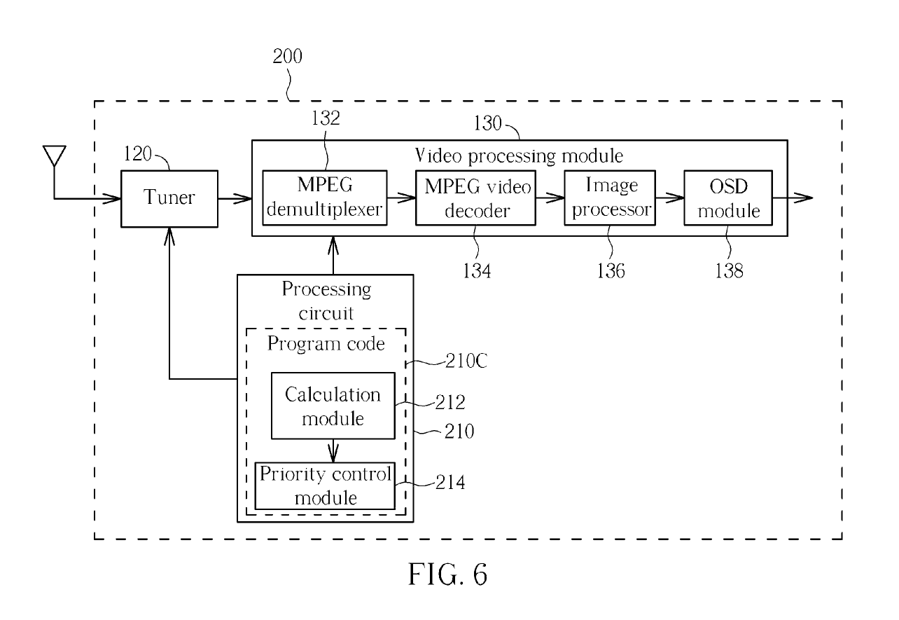

FIG. 6 is a diagram of an apparatus 200 for performing intelligent recommendation/selection of multichannel broadcasting programs according to a second embodiment of the present invention. According to this embodiment, the processing circuit mentioned above can be implemented by utilizing a processing circuit executing a program code 210C, and therefore, can be labeled with another numeral 210 in response to the change in architecture, where the apparatus mentioned above can be labeled with the numeral 200 in response to the change in architecture. In addition, the program code 210C may comprise at least one program module, such as a calculation module 212 and a priority control module 214, where the processing circuit 210 executing the calculation module 212 can perform operations that are the same as or similar to those of the calculation module 112, and the processing circuit 210 executing the priority control module 214 can perform operations that are the same as or similar to those of the priority control module 114. Similar descriptions are not repeated for this embodiment.

It is an advantage of the present invention that the present invention method and apparatus can server the user well. In addition, the user can utilize the multimedia player to view a multichannel broadcasting program in time, having no need to go finding an electronic program guide (EPG) or the like.

Those skilled in the art will readily observe that numerous modifications and alterations of the device and method may be made while retaining the teachings of the invention.

1. A method for performing intelligent recommendation/selection of multichannel broadcasting programs, the method comprising:
calculating a difference between a start time of each of at least one portion of the multichannel broadcasting programs and a specific time; and
setting priority of each of the at least one portion of the multichannel broadcasting programs according to the difference, for use of performing intelligent recommendation/selection.

2. The method of claim 1, wherein the at least one portion of the multichannel broadcasting programs comprises a first multichannel broadcasting program and a second multichannel broadcasting program; and the step of calculating the difference between the start time of each of the at least one portion of the multichannel broadcasting programs and the specific time further comprises:
calculating a first difference between a first start time of the first multichannel broadcasting program and the specific time; and
calculating a second difference between a second start time of the second multichannel broadcasting program and the specific time.

3. The method of claim 2, wherein the first difference is an absolute value of a difference between the first start time and the specific time; and the second difference is an absolute value of a difference between the second start time and the specific time.

4. The method of claim 2, wherein the step of setting the priority of each of the at least one portion of the multichannel broadcasting programs according to the difference for use of performing intelligent recommendation/selection further comprises:
when the first difference is less than the second difference, setting priority of the first multichannel broadcasting program to be higher than that of the second multichannel broadcasting program, for use of performing intelligent recommendation/selection.

5. The method of claim 1, further comprising:
in a normal recommending (NR) mode, in response to trigger from a user, providing the user with a recommending list, wherein the recommending list comprises at least one recommended channel corresponding to at least one multichannel broadcasting program of the multichannel broadcasting programs.

6. The method of claim 1, further comprising:
in an automatic recommending (AR) mode, when a current multichannel broadcasting program comes to an end, automatically switching/tuning to a channel corresponding to a multichannel broadcasting program to be viewed, wherein the multichannel broadcasting program to be viewed is automatically selected from the at least one portion of the multichannel broadcasting programs.

7. The method of claim 6, wherein the specific time is a current time; and the method further comprises:
in the AR mode, when an ending time of the current multichannel broadcasting program falls within a predetermined period since the current time, prompting the user with a message indicating the multichannel broadcasting program to be viewed.

8. The method of claim 1, further comprising:
in an intelligent program-viewing plan (IPP) mode, providing a user with at least one hint through a user interface module, allowing the user to designate a preferred program-viewing plan within a plurality of program-viewing plans, wherein the preferred program-viewing plan is associated to a recommending list comprising at least one recommended channel corresponding to at least one multichannel broadcasting program of the multichannel broadcasting programs.

9. The method of claim 1, further comprising:
providing a user with at least one hint through a user interface module, allowing the user to login for recording user preference statistics data corresponding to the user, for use of user preference control (UPC), wherein the user preference statistics data comprises data regarding multichannel broadcasting program(s) that are most viewed by the user; and
in one of a normal recommending (NR) mode, an automatic recommending (AR) mode, and an intelligent program-viewing plan (IPP) mode, setting the priority of each of the at least one portion of the multichannel broadcasting programs according to the user preference statistics data.

10. The method of claim 1, wherein the specific time is a current time.

11. An apparatus for performing intelligent recommendation/selection of multichannel broadcasting programs, the apparatus comprising:
a processing circuit arranged to perform intelligent recommendation/selection, wherein the processing circuit comprises:
a calculation module arranged to calculate a difference between a start time of each of at least one portion of the multichannel broadcasting programs and a specific time; and
a priority control module arranged to set priority of each of the at least one portion of the multichannel broadcasting programs according to the difference, for use of performing intelligent recommendation/selection.

12. The apparatus of claim 11, wherein the at least one portion of the multichannel broadcasting programs comprises a first multichannel broadcasting program and a second multichannel broadcasting program; and the calculation module calculates a first difference between a first start time of the first multichannel broadcasting program and the specific time, and calculates a second difference between a second start time of the second multichannel broadcasting program and the specific time.

13. The apparatus of claim 12, wherein the first difference is an absolute value of a difference between the first start time and the specific time; and the second difference is an absolute value of a difference between the second start time and the specific time.

14. The apparatus of claim 12, wherein when the first difference is less than the second difference, the priority control module sets priority of the first multichannel broadcasting program to be higher than that of the second multichannel broadcasting program, for use of performing intelligent recommendation/selection.

15. The apparatus of claim 11, wherein in a normal recommending (NR) mode, in response to trigger from a user, the processing circuit provides the user with a recommending list through a user interface module; and the recommending list comprises at least one recommended channel corresponding to at least one multichannel broadcasting program of the multichannel broadcasting programs.

16. The apparatus of claim 11, wherein in an automatic recommending (AR) mode, when a current multichannel broadcasting program comes to an end, the processing circuit controls a tuner to automatically switch/tune to a channel corresponding to a multichannel broadcasting program to be viewed; and the multichannel broadcasting program to be viewed is automatically selected from the at least one portion of the multichannel broadcasting programs.

17. The apparatus of claim 16, wherein the specific time is a current time; and in the AR mode, when an ending time of the current multichannel broadcasting program falls within a predetermined period since the current time, the processing circuit prompts the user with a message indicating the multichannel broadcasting program to be viewed.

18. The apparatus of claim 11, wherein in an intelligent program-viewing plan (IPP) mode, the processing circuit provides a user with at least one hint through a user interface module, allowing the user to designate a preferred program-viewing plan within a plurality of program-viewing plans; and the preferred program-viewing plan is associated to a recommending list comprising at least one recommended channel corresponding to at least one multichannel broadcasting program of the multichannel broadcasting programs.

19. The apparatus of claim 11, wherein the processing circuit provides a user with at least one hint through a user interface module, allowing the user to login for recording user preference statistics data corresponding to the user, for use of user preference control (UPC); the user preference statistics data comprises data regarding multichannel broadcasting program(s) that are most viewed by the user; and in one of a normal recommending (NR) mode, an automatic recommending (AR) mode, and an intelligent program-viewing plan (IPP) mode, the processing circuit sets the priority of each of the at least one portion of the multichannel broadcasting programs according to the user preference statistics data.

20. The apparatus of claim 11, wherein the specific time is a current time.
